(19) United States
(12) Patent Application Publication
(10) Pub. No.: US 2018/0111818 A1
(43) Pub. Date: Apr. 26, 2018

(54) Actuator Heating Apparatus

(71) Applicant: Ronald G. Havlovick, Plano, TX (US)

(72) Inventor: Ronald G. Havlovick, Plano, TX (US)

(21) Appl. No.: 15/299,657

(22) Filed: Oct. 21, 2016

(51) Int. Cl. B67D 7/32; B67D 7/82

(52) U.S. Cl. CPC B67D 7/32; B67D 7/82

(57) ABSTRACT

A liquid dispenser to dispense heated liquid may include a container to hold the liquid; a heating element to heat the liquid as the liquid is being dispensed; and an adjustment control device to control the heating of the heating element.

### FIELD OF THE INVENTION

The present invention relates to an actuator and more particularly to an actuator heating device.

### BACKGROUND

In most common lotion or gel or liquid application, the bottle is uniformly round or oval, and the lotion or gel or liquid is applied by a push actuator. In this push actuator, the lotion or gel or liquid is pumped into a tube through a dispenser onto the hand.

The most common bottle of this lotion or gel or liquid is made of plastic.

In present art, the heating apparatus suffers from either having the heating element within the bottle itself in direct conduction with the lotion or gel or liquid, or in some way, attaching to the bottle and conducting heat through the bottle into the lotion or gel or liquid or having to remove the lotion or gel or liquid into another apparatus for heating

In present art, in the event of a short or wear, the electrical heating element becomes in direct contact with the entire lotion or gel or liquid within the bottle, which then exists a possible shock or fault. In present art, there is no mention of how this heating element if removed from the lotion or gel or liquid, would be detected to ensure no human injury. Also, in the event the lotion or gel or liquid is exhausted or entirely used, and the heating element is within the bottle, how this heating element does not deform or melt the bottle itself or potentially cause injury to the user. In effect, the present art does not indicate a no lotion or gel or liquid sensor. Also, the present art, does not indicate at which time the lotion or gel or liquid would commence heating. In effect, the present art does not indicate a motion or touch sensor which then indicates to begin lotion or gel or liquid heating.

Present art also does not indicate if the bottle itself were to be heated, via an attachment to the bottle, in effect a plastic bottle, how the plastic bottle would not potentially melt or deform causing the bottle to rupture or leak. Present art denotes a heating element, but does not address a uniform method of attachment into today's plastic bottles and a method to ensure user safety.

Further, present art does not indicate if the heating element itself malfunctions or becomes inoperative or unsafe the heating element's power is disconnected. In effect, an over current or over voltage detection to ensure the heating element's power turns off in the event of the heating element becoming unusable or unsafe.

### SUMMARY

A lotion or gel or liquid dispenser to dispense heated lotion or gel or liquid may include a container to hold the lotion or gel or liquid; a heating element to heat the lotion or gel or liquid as the lotion or gel or liquid is being dispensed; an adjustment control device to control the heating of the heating element; a sensor to determine when the user wishes the lotion or gel or liquid to be dispensed and thereby heated; a sensor to indicate when there is no lotion or gel or liquid to heat within the dispensing tube or chamber; and a sensor to indicate heating element malfunction

The lotion or gel or liquid sensor may include a first sensor at a dispensing position to sense touch of the user.

The lotion or gel or liquid sensor may include a second sensor at a dispensing position to sense motion of the user.

The lotion or gel or liquid sensor may include a third sensor at an attachment position to sense touch of the user.

The lotion or gel or liquid sensor may include a fourth sensor at an attachment position to sense motion of the user.

The lotion or gel or liquid sensor may include a fifth sensor at the dispensing point to sense lotion or gel or liquid.

The lotion or gel or liquid sensor may include a sixth sensor at the initiation(internal tube) point to sense lotion or gel or liquid.

The lotion or gel or liquid sensor may include a seventh sensor at the reservoir point to sense lotion or gel or liquid.

The lotion or gel or liquid sensor may include an eighth sensor at the dispensing point to sense temperature of the lotion or gel or liquid.

The lotion or gel or liquid sensor may include a ninth sensor at the initiation point to sense temperature of the lotion or gel or liquid.

The lotion or gel or liquid sensor may include a tenth sensor within the reservoir to sense temperature of the lotion or gel or liquid.

The heating element may include a first induction coil positioned in the container.

The heating element may include a second induction coil positioned between the attachment position and the dispensing position.

The heating element may include a third induction coil positioned around the container within the attachment position.

The heating element may include a vibration coil.

The heating element may include a radio frequency (RF) coil.

The heating element may include a capacitive plate or plates (dielectric heating.).

The heating element may include a capacitive mesh (dielectric heating).

The heating element may include a metal radiator (conduction heating).

The heating element sensor may include a sensor at the heating element to sense heating element malfunction.

The heating element power source maybe a transformer.

The heating element power source maybe a magnet and wire coil producing power by movement of the actuator.

The heating element power source maybe a piezo electric element producing power by movement and force of the actuator.

The heating element sensor may include a sensor at the transformer to sense heating element malfunction.

The heating element transformer may include a method to disconnect power in the event of a heating element malfunction.

The heating element magnet and wire coil may include a method to disconnect power during actuator movement in the event of a heating element malfunction.

The heating element piezo electric element may include a method to disconnect power during actuator movement in the event of a heating element malfunction.

The adjustment control device may be positioned on a transformer.

The adjustment control device may be positioned at a dispensing position.

A valve maybe within the dispensing tube to control the amount of lotion or gel or liquid to be dispensed.

A valve maybe within the dispensing tube to control the time in which the lotion or gel or liquid heats before lotion or gel or liquid dispenses.

### BRIEF DESCRIPTION OF THE DRAWINGS

The invention may be understood by reference to the following description taken in conjunction with the accompanying drawings, in which, like reference numerals identify like elements, and in which:

FIG. 1A and illustrates an actuator heater apparatus of the present invention with the heating element within the intake tube;

FIG. 1B illustrates another embodiment of the actuator heater apparatus of the present invention with the heating element within the attachment position and dispensing position tube;

FIG. 1C illustrates another embodiment of the actuator heater apparatus of the present invention with the heating element within the dispensing tube;

FIG. 1D illustrates a portion of the actuator heater apparatus of the present invention depicting a metal radiator within the dispensing tube;

FIG. 2A illustrates another embodiment of the actuator heater apparatus of the present invention with the heating element being a reservoir in the actuator housing;

FIG. 2B illustrates another embodiment of the actuator heater apparatus of the present invention with the power source of the heating element being a magnet and wire coil in the actuator housing with an integral valve to control the time lotion or gel or liquid heats before dispensing;

FIG. 2C illustrates another embodiment of the actuator heater apparatus of the present invention with the power source of the heating element being a piezo electric element in the actuator housing with an integral valve to control the time lotion or gel or liquid heats before dispensing;

FIG. 3A illustrates another embodiment of the actuator heater apparatus of the present invention with the heating element being embodied within a sock or booty which can be pulled over the actuator housing;

FIG. 3B illustrates a portion of the actuator heater apparatus of the present invention with the heating element being embodied within a sock or booty pulled over the actuator housing;

### DETAILED DESCRIPTION

In one embodiment, the present invention depicts a heating element by magnetic induction. A coil may be positioned either around a metal tube, a reservoir or radiated to a solid iron metal rod.

In another embodiment, a vibration coil may transfer heat into the lotion or gel or liquid by means of a magnetic field. Similar to magneto hydrodynamic drive, only in this case, the lotion or gel or liquid is moved back and forth generating its own internal molecular friction, and therefore heating the lotion or gel or liquid.

In another embodiment, the present invention employs an RF coil around a plastic or other such tube on the inside of the lotion or gel or liquid dispensing tube. In this case, RF Energy or electric field is radiated inward and encompasses the lotion or gel or liquid. The RF Energy heats the lotion or gel or liquid by electron excitation, similar to microwave heating. Here, because of the lotion or gel or liquid is in close proximity to the RF Coil, the radiated energy is far less than that required for a microwave oven. Here again, because of the ballistic electron bombardment of the lotion or gel or liquid electron, the movement results in internal heating of the lotion or gel or liquid.

In another embodiment, the present invention employs a capacitive plate or mesh on each side of the dispensing tube to form a capacitor with the lotion or gel or liquid as the dielectric and by sinusoidal voltage at a specific frequency to cause molecular reversal and thereby heat within the lotion or gel or liquid. This is called capacitive dielectric heating.

In another embodiment, the external transformer is eliminated, and the power electronics are moved integral to the actuator. The coil surrounding a magnet is activated when the user manual depresses the actuator, and the magnet is moved within the coil producing an electric current. This electric current is then used as the power source for the other embodiments previously discussed. A valve is positioned within the dispenser of the actuator to ensure the lotion or gel or liquid stays within the actuator during the actuator depression to ensure there is sufficient time for the heating of the lotion or gel or liquid to occur.

In another embodiment, again, the external transformer is eliminated, and the power electronics are positioned integral to the actuator. The use of a piezo element is used such that when the user depresses the actuator, the piezo element is mounted below the spring, such that the spring exerts force and pressure against the piezo element, thereby producing an electric current. This electric current is then used as the power source for the other embodiments previously discussed. A valve is positioned within the dispenser of the actuator to ensure the lotion or gel or liquid stays within the actuator during the actuator depression to ensure there is sufficient time for the heating of the lotion or gel or liquid to occur.

In another embodiment the heating element is an internal mesh or honeycomb or radiator and is heated by means of electric current. The internal radiator is made of resistive material such that upon application of electric current transfers heat into the lotion or gel or liquid by conduction. In another embodiment the heating element is in the form of a sock or booty which can be pulled over and thereby encompasses the actuator dispenser. Within this sock or booty is an inductor coil or capacitive plate or mesh and pursuant to the aforementioned method using a coil or capacitive plates is then used to heat the lotion or gel or liquid.

In all embodiments, the actual bottle, plastic or otherwise, is not heated, but only that portion of the lotion or gel or liquid desired by the user is heated.

A lamp or LED of such will illuminate to indicate the Power Control is connected to the dispensing apparatus. The lamp or led may illuminate a fixed color or change color in reference to the temperature control set by the user. Still in another, the lamp or led may illuminate only when the user is dispensing the heated lotion or gel or liquid.

Four sensors, as mentioned above, one for motion or touch, another for temperature, another to sense lotion or gel or liquid, and another for power sensing are to sense lotion or gel or liquid user demand, to maintain user desired temperature, to ensure lotion or gel or liquid is present, and to ensure if an electrical failure or malfunction of some sort, a safety shut off.

The touch or motion sensor indicates when the heating process is to begin, at the touch or downward pressure (motion) of the actuator. This ensures a discontinuous use of power, and if the actuator is removed from the lotion or gel or liquid, since there would be no downward touch or motion, the heating element is off. Thereby ensuring do to handling while the actuator is connected to its power source, the actual heating element is off. Since there is no indication of user demand for lotion or gel or liquid, there is no power or heat providing safety to the user.

The temperature sensor is to ensure the correct temperature is maintained for the desired user comfort.

The lotion or gel or liquid sensor is to indicate in the event there is no lotion, gel or liquid around or the actuator has been removed, there is no need for a heating effect for there is nothing to heat. Either the lotion or gel or liquid has been consumed or the actuator has been removed from the lotion or gel or liquid bottle. In either case this would cause a shutdown of all power to the heating element ensuring that there would be no accidental injury to the user.

The power sensor is to indicate in the advent of an electrical fault of some kind there is no danger to the user. Since the amount of power to the heating element is monitored within the power control any increase of this power is call for alarm and a shutdown of all power to the heating element.

Therefore, in this invention, the user wishes to have heated lotion or gel or liquid for comfort onto the skin or body or other such use. In today's applications these lotions or gels or liquids are applied via a manual pump actuator, normally within a plastic bottle.

The present invention encompasses a method to dispense lotion or gel or liquid by a manual pump actuator, for the user to control the temperature of the dispensing lotion or gel or liquid, a method to monitor the temperature of the lotion or gel or liquid, a method to detect when the user wishes the lotion or gel or liquid to dispense, a method to control when to begin heating of the lotion or gel or liquid, a method to determine if lotion or gel or liquid is present, a method to heat the lotion or gel or liquid, a method of remote power and control away from the lotion or gel or liquid bottle and dispenser, a method to produce power by the depression of the actuator via a magnet and coil or piezo element, a safety mechanism to ensure if the actuator is removed from the bottle, a safety mechanism to ensure if the power source faults in some way and all power is removed, a method to indicate power is connected and operating to the heating element and a method of universally fitting the actuator to all plastic bottles as is today's art for lotion or gel or liquid.

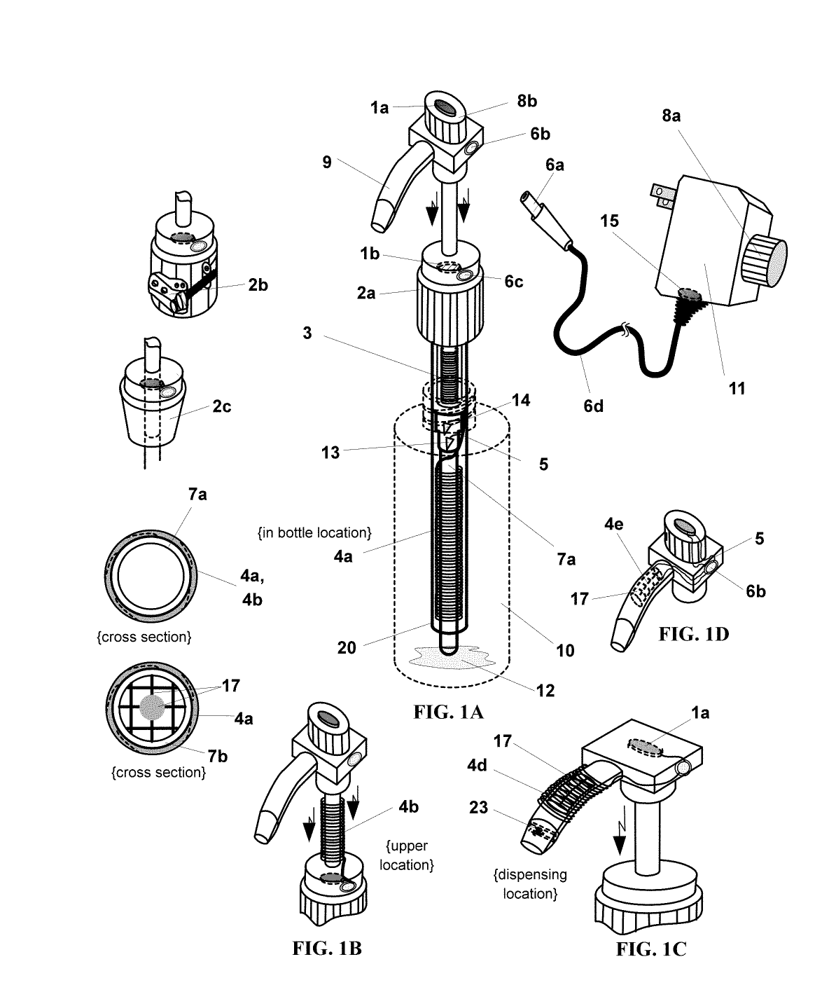

FIG. 1A illustrates an actuator heating apparatus 100 of the present invention and may include a first sensor la positioned at the dispensing position to detect the user activating the actuator heating apparatus, a universal threaded cap 2a to connect to the container 10 which may be connected to a biasing device 3 such as a spring, a second sensor 1b which may be positioned at the attachment position adjacent to the cap 2a and a heating element 4a which may be a first induction coil positioned in the container 10. The actuator heating apparatus 100 may also include a connection wire 5 from the electrical power to the first induction coil 4a, a male connector 6a to connect to the power supply, a first female connector 6b positioned at a dispensing position to connect to the male connector 6a or a second female connector 6c positioned at the attachment position to connect with the male connector 6a.

The actuator heating apparatus 100 may include a container attachment device 2 which may include a threaded cap 2a, a clamp device 2b as shown or a plug device 2c as shown in FIG. 1a. FIG. 1a illustrates a temperature adjustment device which may include a first adjustment control device 8a positioned on the transformer to control power on the power line or a second adjustment control device 8b positioned at the dispensing position to control power. Figure la additionally illustrates a dispenser device 9 to dispense the fluid which may be lotion/gel/liquid from the container 10. FIG. 1a additionally illustrates a biasing device 3 which may be a spring to bias the bottle attachment device 2.

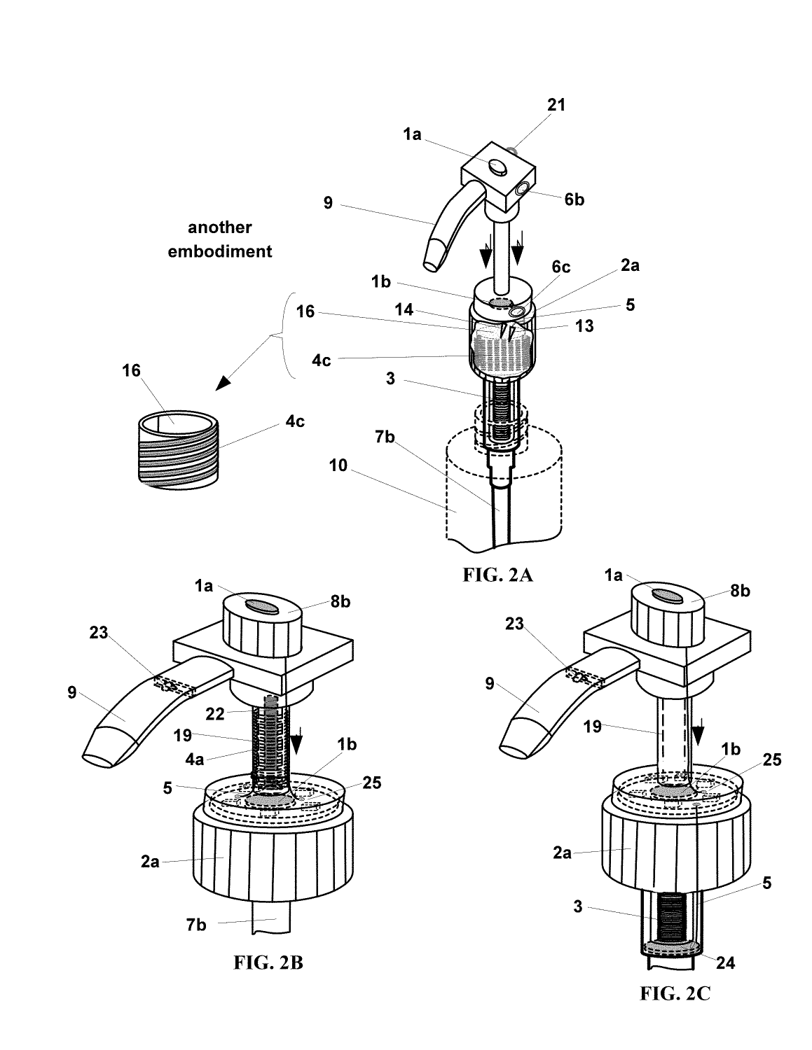

FIG. 1a additionally illustrates an outer protective covering or sheath 20 to prevent the user from inadvertently touching the heat inducing element 4 and illustrates a lotion/gel/liquid 12 within the container 10. An intake tube 7 which may be iron, metal or ferrite transmits the fluid/lotion/gel/liquid; FIG. 2a illustrates a plastic intake tube 7b. FIG. 1a illustrates a lotion/gel/liquid sensor 14 to sense the lotion/gel/liquid and illustrates an electric current sensor 15 to sense the electric current.

FIG. 1b illustrates another embodiment with the induction coil 4b positioned between the attachment position and dispensing position.

FIG. 1c illustrates another embodiment with the induction coil 4d positioned around the dispensing point.

A cross-sectional view of the induction coil positioned in the bottle 4a and illustrates the second induction coil positioned between the attachment position and the dispensing position 4b. In addition, the intake tube 7 is illustrated.

Another cross-sectional view of the induction coil 4a and internal heating rod or radiator 17 positioned within the dispensing tube 9 or intake tube 7a. FIG. 1a illustrates the clamp device 2b.

FIG. 1a illustrates the plug device 2c.

FIG. 2a illustrates a power indicator lamp 21 to indicate when power is supplied, a touch or motion sensor 1a, 1b to detect touch or motion. A iron metal or ferrite reservoir 16 (shown in FIG. 2a) and in another embodiment the induction coil 4c (shown in FIG. 2a) and a plastic intake tube 7b.

FIG. 1d illustrates a solid or semisolid or radiator iron or ferrite rod 17, a dispensing tube 4a, electrical wire 5, and female power connector inlet 6b.

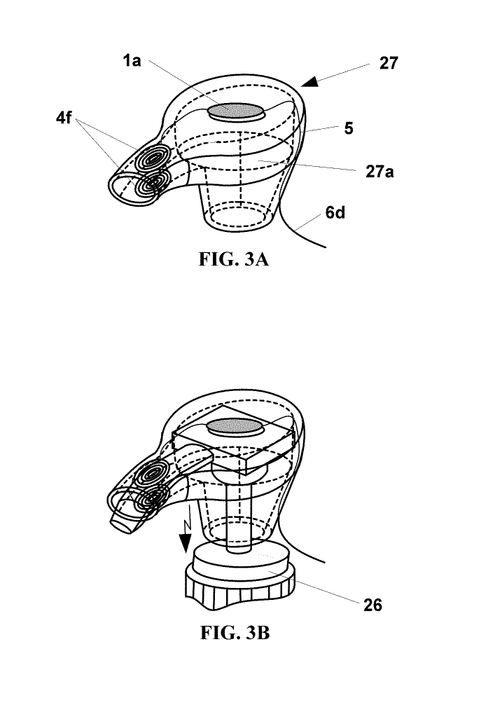

FIG. 3A illustrates another embodiment of the actuator heater apparatus 100 of the present invention with the heating element being embodied within a sock or booty 27 which can be pulled over the actuator housing with capacitive plates 4f.

FIG. 3B illustrates a portion of the actuator heater apparatus 100 of the present invention with the heating element being embodied within a sock or booty 27 pulled over the actuator housing.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A liquid dispenser to dispense heated fluid, comprising;
a heating element to heat the fluid as the fluid is being dispensed;
an adjustment control device to control the heating of the heating element, and
wherein the automatic control device includes a valve to prevent the flow of the fluid from the liquid dispenser for a sufficient time to heat the fluid.

2) A fluid dispenser to dispense heated fluid as in claim 1, wherein the fluid dispenser includes a first sensor at a dispensing position to sense touch of the user.

3) A fluid dispenser to dispense heated fluid as in claim 2, wherein the fluid dispenser includes a second sensor at a dispensing position to sense motion of the user.

4) A fluid dispenser to dispense heated fluid as in claim 3, wherein the fluid dispenser includes a third sensor at an attachment position to sense touch of the user.

5) A fluid dispenser to dispense heated fluid as in claim 4, wherein the fluid dispenser includes a fourth sensor at an attachment position to sense motion of the user.

6) A fluid dispenser to dispense heated fluid as in claim 1, wherein the heating element includes a first induction coil positioned in the container.

7) A fluid dispenser to dispense heated fluid as in claim 6, wherein the heating element includes a second induction coil positioned between the attachment position and the dispensing position.

8) A fluid dispenser to dispense heated fluid as in claim 7, wherein the heating element includes a third induction coil positioned around the container within the attachment position.

9) A fluid dispenser to dispense heated fluid as in claim 1, wherein the heating element includes a vibration coil.

10) A fluid dispenser to dispense heated fluid as in claim 1, wherein the heating element includes a radio frequency (RF) coil.

11) A fluid dispenser to dispense heated fluid as in claim 1, wherein the adjustment control device is positioned on a transformer.

12) A fluid dispenser to dispense heated fluid as in claim 1, wherein the adjustment control device is positioned at a dispensing position.

13) A fluid dispenser to dispense heated fluid as in claim 1, wherein the heat is activated in response to motion or touch of the user.

14) A fluid dispenser to dispense heated fluid as in claim 1, wherein the device is inactivated in response to heating element malfunction.

15) A fluid dispenser to dispense heated fluid as in claim 2, wherein the first sensor detects an absence of fluid.

16) A fluid dispenser to dispense heated fluid as in claim 15, wherein the first sensor indicates the temperature of the fluid.

17) A fluid dispenser to dispense heated fluid as in claim 1, wherein the heating element is a capacitive plate or dielectric heating.

18) A fluid dispenser to dispense heated fluid as in claim 1, wherein the heating element is a radiator and heating the fluid by conduction.

19) A fluid dispenser to dispense heated fluid as in claim 1, wherein the heating element is connected to a reservoir.
